(19) United States
(12) Patent Application Publication
(10) Pub. No.: US 2005/0075933 A1
(43) Pub. Date: Apr. 7, 2005

(54) System and method of improving customer health, reducing income tax by charitable gift, and providing hunger relief for the needy

(76) Inventor: James C. Crone, Goldsboro, NC (US)

Correspondence Address: COATS & BENNETT, PLLC, P O BOX 5, RALEIGH, NC, 27602, US

(21) Appl. No.: 10/680,678

(22) Filed: Oct. 7, 2003

(51) Int. Cl. G06F 17/60

(52) U.S. Cl. 705/15

(57) ABSTRACT

A method, by a restaurant, of improving customer health, promoting hunger relief, and facilitating charitable giving by documenting tax deductible charitable gifts, comprises selling a reduced-portion meal product to a customer at the price of a corresponding full-portion meal product. The excess amount of funds collected (the price less the cost of the reduced-portion meal product) less an operating fee, and any additional funds donated by the customer, are transferred to a charity on the customer's behalf, such as a food bank or other hunger relief charity. A receipt memorializes the sale and documents the charitable donation. A customer may be issued a unique identifier, such as a card, upon the first purchase of a reduced-portion meal product. Upon subsequent purchases, the card identifies the customer and tracks his charitable donations. The customer periodically provided with a summary, such as to document tax deductions claimed for the charitable donations.

### BACKGROUND OF THE INVENTION

The present invention relates generally to the field of restaurants and in particular to a system and method of facilitating charitable hunger relief by restaurant customers while promoting their health and providing documentation for charitable gift tax deductions.

Americans are increasingly overweight. According to a 2000 study, close to two-thirds of adults (64.5%) are either obese or overweight; that is nearly two out of every three Americans. Overweight is defined as a Body Mass Index (BMI) of 25 or higher. A BMI of 30 or higher defines obesity, and 40 or higher extreme obesity. By this metric, nearly one-third of adults (30.5%), close to 59 million people, are considered obese, and 4.7%, over 9 million, are extremely obese. The epidemic affects children as well. Among children and adolescents aged 6 to 19 years, 15% were measured as overweight (BMI at or above the 95th percentile of sex-specific BMI growth charts), a four percent increase from the last survey. Furthermore, 10 percent of children between the ages of 2 and 5 are now overweight.

Excess weight and physical inactivity account for 300,000 premature deaths each year. A US Surgeon General's report on obesity in 2001 noted that illness directly related to obesity had cost the country $120 billion dollars annually. The amount is growing exponentially and will soon approach the $150 billion dollar cost to public health attributed to tobacco. For many Americans, obesity can be an invitation to high blood pressure, high cholesterol, type-2 diabetes, heart disease, stroke, gall bladder disease, arthritis, sleep/breathing disturbances, and even cancer.

While many lifestyle factors such as lack of sufficient exercise contribute to Americans' overweight condition, one potentially significant factor is growing size of portions in meal products offered by restaurants. For example, one fast food restaurant offers a burger comprising two ⅓-pound Angus beef patties, two slices of American cheese, bacon strips, red onions, leaf lettuce and tomato. This burger alone—without the accompanying fries and soda—contains 1,148 calories and 82 grams of fat. This is half of the calories and more fat than the USDA recommends most Americans consume in an entire day. Exacerbating the problem of increasingly unhealthy levels of salt, sugar and fat in individual fast food restaurant products, widespread promotional efforts to increase sales include increased-portion meal products, known variously as “supersize,” “biggie,” and “value” meals, whereby the customer may purchase increased portions of, for example, the fries and soda that accompany a burger as a packaged meal product.

The overweight and obesity data, and the plethora of fast food restaurants pushing increased-portion meal products, would indicate that Americans are well fed. However, the reality is that hunger is a significant and ongoing problem in America. The U.S. Department of Agriculture estimates that 13 million children live in households that do not have an adequate supply of food. 23.3 million Americans (roughly 9% of all Americans) receive emergency hunger-relief services each year, including more than nine million children, roughly a million more than the total population of New York City. Virtually every community has some organization, from food banks to soup kitchens, to provide hunger relief.

Finally, Americans are philanthropic. Charitable contributions in the U.S. for the year 2002 are estimated at nearly $241 billion. Of this, over 76%, or $184 billion came from individuals (the remainder given by independent and community foundations). Charitable giving by individuals is encouraged by the tax code, which offers most individuals the opportunity to deduct charitable contributions from their taxable income, but only if the donations are documented. While Americans are typically generous in charitable giving, many resent the barrage of direct mail, broadcast media, and telemarketing advertisements produced by or for many charitable organizations soliciting donations. Many people prefer a more spontaneous form of giving, such as contributing to various fundraising and collection efforts they encounter during their daily activities. However, these donations are rarely documented, and the donors are often deprived from taking legitimate tax deductions for them. In addition, there may be no benefit or incentive to the donor, other than the satisfaction of the gift itself. Such a benefit may increase the amount and/or frequency of charitable donations.

There exists a need in the art for an easy, convenient form of charitable donation, which individuals may encounter often in their routine activities, that produces documentation of the donation for the donor. In particular, there exists a need to both reduce the consumption of unhealthy food by individuals, and to provide food to the hungry in America. In addition, a need exists to incentivize charitable contributions by providing documentation for tax deductions.

### SUMMARY OF THE INVENTION

The present invention relates to a method of both improving customer health and providing a deduction for charitable gifts, in particular gifts to feed the needy, by a restaurant. The method comprises selling a reduced-portion meal product to a customer at the price of a corresponding full-portion meal product, and collecting at least that price in funds from the customer. The price comprises a base amount corresponding to the cost of the reduced-portion meal product and an excess amount that is the difference between that cost and the price. The method further comprises transferring part of the excess amount and any additional funds donated by a customer to a charity on behalf of the customer. The part of the excess amount transferred to the charity may comprise the excess amount less an operating fee retained by the restaurant. The customer is provided a receipt memorializing the sale and documenting the charitable donation.

In one embodiment of the present invention, the customer is issued, upon the first purchase of a reduced-portion meal product, a card with unique identifier encoded thereon. Upon subsequent purchases, the card identifies the customer and tracks his reduced-portion meal product purchases. The customer may periodically receive with a summary of his charitable donations for tax purposes.

### BRIEF DESCRIPTION OF DRAWINGS

FIG. 1 is a block diagram of a system according to the present invention.

FIG. 2 is flow diagram of a method according to the present invention.

### DETAILED DESCRIPTION OF THE INVENTION

The present invention relates to a system and method implemented by a restaurant, for example a fast food restaurant, to both improve customer health and to facilitate and implement charitable contributions on behalf of customers. Many restaurants offer a variety of expanded-portion meal products at prices incrementally higher than corresponding full-portion meal products—the familiar “super size” meal products. According to the present invention, the restaurant offers a reduced-portion meal product at the same price as a corresponding full-portion meal product, with part of the price difference being transferred to a charity, such as hunger relief, on behalf of the customer. The reduced-portion meal product may be known as a “heart-to-heart meal,” or other brand name.

Each reduced-portion meal product comprises the same elements as its corresponding full-portion meal product, but in reduced quantities. For example, a typical reduced-portion meal product may comprise a single hamburger in lieu of a double, a small order of fries in lieu of a large, and a small drink in lieu of a medium. The price for this reduced-portion meal product would be the same as that for a corresponding meal product comprising a double hamburger, large fries, and a medium drink. The price charged for the reduced-portion meal product (equal to the price of the full-portion meal product) comprises two parts: a base amount that represents the cost for the restaurant to prepare and sell the reduced-portion meal product, and an excess amount, which is the difference between the base amount and the sale price (i.e., the price of the full-portion meal product).

According to the present invention, a portion of the excess amount collected by the restaurant from the customer is donated to a charitable organization on the customer's behalf. The portion of the excess amount donated may be the excess amount less an operating fee retained by the restaurant to cover the costs of implementing the system. For example, a reduced-portion meal product comprising half of the food of a corresponding full-portion meal product may sell for a price, of which half is a base amount (the cost of the reduced-portion meal product) and half is an excess amount. The restaurant may retain for example a 10% operating fee, thus donating 40% of the price of the reduced-portion meal product to a charity on the customer's behalf. Of course, those of skill in the art will readily recognize that a wide variety of reduced-portion meal product configurations, with concomitant cost and price structures, as well as operating fees, are possible within the broad practice of the present invention.

In addition to the excess amount built into the price of the reduced-portion meal product (less restaurant operating fee), the customer may make an additional charitable donation at the point of sale, for example, “rounding up” his purchase to the next dollar or other convenient denomination, and directing the “change” to go to the charity. Such additional contributions by the customer are also forwarded to a charitable organization.

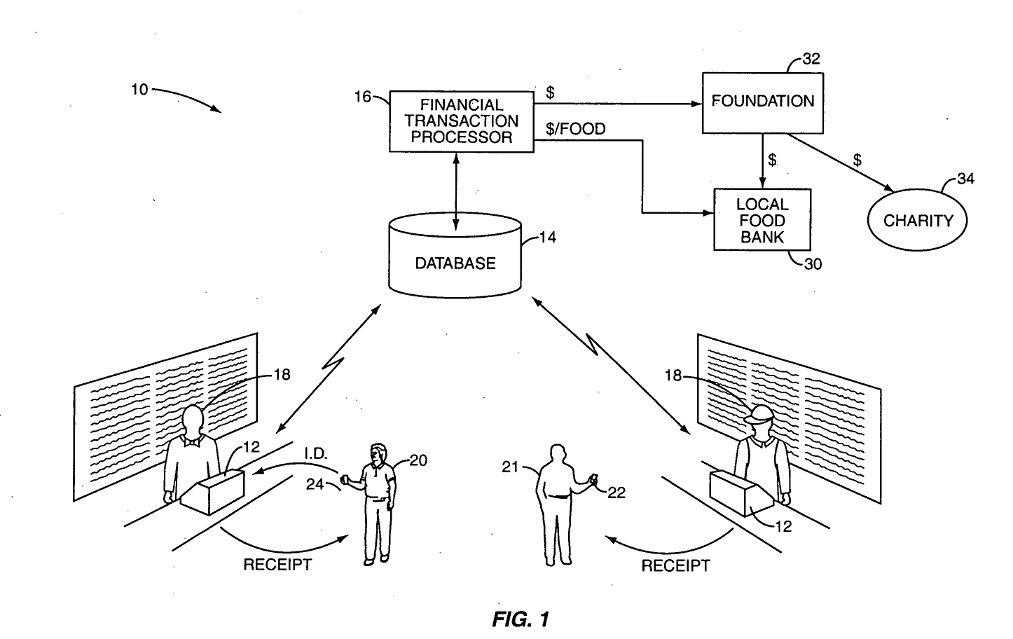

FIG. 1 depicts, in functional block diagram form, one embodiment of a system, indicated generally by the numeral 10, of the present invention. The core elements of the system 10 include one or more Point Of Sale (POS) stations 12, a database 14, and a financial transaction processor 16.

The POS stations 12 are used by restaurant personnel 18 to record the sale of a reduced-portion meal product to customers 20, 21. The POS station 21 records the funds received from the customer 20, 21 attributable to the reduced-portion meal product and additionally any excess funds that the customer 20, 21 directs to the charitable donations. In one embodiment, the customer 20, 21 may select a particular charity from among a plurality of charities, or may select two or more available charities and direct how the donation is to be divided among them. This information may be entered into the POS 12 along with the reduced-portion meal product purchase and any excess funds donated by the customer 20, 21. The POS station 12 generates documentation, such as a receipt 22 (depicted in relationship to customer 21, although every customer 20, 21 would be issued a receipt 22), memorializing the transaction and indicating the excess amount of funds that the restaurant will donate to a charitable organization on behalf of the customer 21. The customer 20, 21 is provided with this documentation for future use, such as for example, to document a claimed tax deduction.

The POS stations 12 communicate via wired or wireless telecommunications paths to a database 14, as is well known in the art. The database 14 may receive transaction information from a large plurality of POS stations 12, such as all of the POS stations 12 of a particular restaurant chain or franchise. Alternatively, the database 14 may be regional, local, or cover only a single restaurant. The database 14 is operative to record at least the charitable donation to be paid by the restaurant on behalf of a customer 20, 21 (e.g., the excess amount of funds collected from the customer 20, 21 less any operational fee), and any excess funds donated by the customer 20, 21. In one embodiment, the database 14 is additionally operative to store the charity or charities to which the customer 20, 21 has directed the charitable donation to be forwarded on his behalf. In one embodiment, further explained below, a unique identifier associated with the customer 20, 21 is additionally stored in the database 14. The database 14 may maintain other information, as necessary or desired.

Associated with the database 14, and in data flow communications therewith, is a financial transaction processor 16. The financial transaction processor 16 is operative to collect data from the database 14 indicative of funds to be transferred to charitable organizations on behalf of customers 20, 21, and to transfer those funds. In one embodiment, the financial transaction processor 16 periodically transfers funds directly to a foundation 32 or similar organization that in turn distributes funds to specific charities, such as a local food bank 30, or other charities, as generally represented by charity 34. When the system of the present invention is implemented on a wide scale by a variety of restaurants, the foundation 32 may perform a clearinghouse function, receiving funds from a variety of restaurants, and distributing those funds to the indicated charitable organizations 30, 34. Alternatively, the foundation 32 may comprise an existing organization, such as for example the United Way.

The financial transaction processor 16 may transfer funds representing charitable donations made on behalf of customers 20, 21 directly to a charity, such as a local food bank 30. Additionally or alternatively, the financial transaction processor 16 may facilitate and implement the charitable donation as an “in-kind” transfer, such as providing food directly to the local food bank 30. Due to its food cost structure, the restaurant may be able to provide greater aid in direct food transfer for a given dollar amount than by providing funds for the charity to purchase food; in this manner, the restaurant may be able “stretch” its customers' 20, 21 charitable contributions to provide a greater beneficial impact.

In one embodiment of the present invention, a customer 20 is provided a unique identifier upon his or her first purchase of a reduced portion meal product. The unique identifier may, for example, comprise a card 24 having an identification number and/or optical code, such as a bar code, printed thereon. Alternatively, the card 24 may contain a magnetic stripe with the unique identifier encoded thereon. As another example, the card 24 may comprise a “smart card,” which contains semiconductor circuits such as a processor and memory. As yet another example, the unique identifier may comprise a radiofrequency identification (RFID) tag, embedded in a card 24, key fob, or the like. In general, any method known in the art to quickly and easily identify customers may be advantageously utilized in supplying a unique customer identification for the purpose of the present invention.

Upon his or her initial purchase of a reduced portion meal product, the customer 20 may be provided with a card 24 containing a unique identifier and the customer 20 may provide personally identifying information, such as a name and address, and optionally a tax identification number. The customer 20 may additionally indicate to which charity or charities he wishes funds to be donated on his behalf on an ongoing basis, and in which percentages or amounts. The unique identifier would then be stored, along with the customer's 20 excess funds and charity designation, if any, in the database 14. The customer's 20 personal identifying information may additionally be stored in the database 14, indexed by the unique identifier. Alternatively, for greater security and to assure the customer 20 of privacy, the customer's 20 personal identifying information may be transferred directly to, e.g., the foundation 32, and all communications between the POS stations 12, the database 14, and the financial transaction processor 16 (i.e., all of the data controlled by the restaurant) indexed by only the customer's 20 unique identifier.

Upon subsequent visits to the restaurants, upon purchasing a reduced-portion meal product, the customer 20 may simply provide the card 20 to be read by the POS 12, and transferred to the database 14 along with information regarding the excess amount and any additional funds. If the customer 20 wishes, he may at this point select a different charity than the “default” charity designated upon issuance of his card 24. In this manner, the customer's 20 purchases of reduced-portion meal products are tracked over time, either the by system 10 or the foundation 32. Periodically, for example in January of each year, either the by system 10 or the foundation 32, whichever maintains the customer's 20 personal identifying information, may send the customer 20 a summary of funds transferred to charitable organizations on his behalf over a predetermined time period, such as the previous year. Such a summary may assist the customer 20 in preparing his tax returns, wherein he may claim a deduction for the charitable contributions.

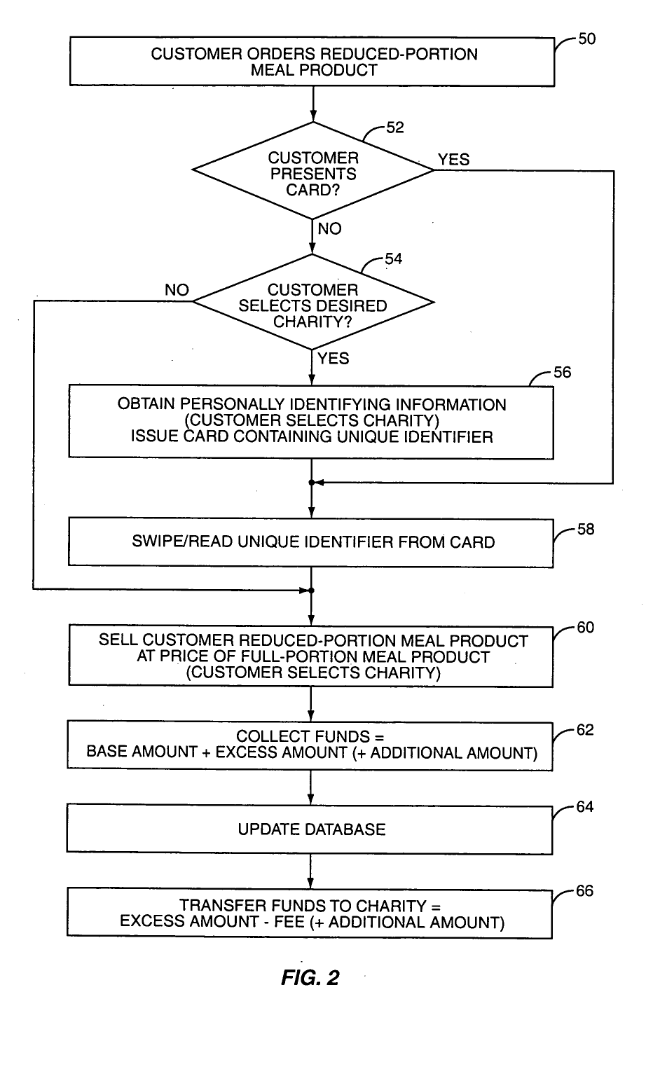

FIG. 2 depicts a flow diagram representation of the method of one embodiment of the present invention. A customer 20 orders a reduced-portion meal product at step 50.

At step 52, the restaurant personnel 18 inquires whether the customer 20 has a card 24 containing a unique identifier. If so, the customer 20 provides the card 24, and control jumps to step 58 where the card 24 is read. If not, control flows to step 54 where the restaurant personnel 18 explains the benefits of the card 24 and asks the customer 20 if he would like to obtain one. If not, control jumps to step 60 where the customer's order is processed. If the customer 20 does desire a card 24, control flows to step 56 where the customer provides personally identifying information (such as name and address, and optionally a tax identification number). The restaurant personnel 18 activates a card 24, associating the unique identifier on the card with the customer's 20 personally identifying information, in a manner well known in the art. At this point, the customer 20 may select a “default” one or more charities from among a plurality, if more than one charity is available. If the customer 20 selects two or more charities, he may designate how his contribution is to be split among them. Various other data, as necessary or desired, may be solicited from the customer 20 and included in the personally identifying information stored by the restaurant or foundation 32.

If the customer 20 already has a card 24 with a unique identifier, he presents it at step 58, and the restaurant personnel 18 swipes or reads the card at an appropriate card reader device at the POS 12. This provides the system 10 with the customer's unique identifier and his default charity choice(s).

At step 60, the restaurant personnel 18 sells the reduced-portion meal product to the customer 20, at the price of a corresponding full-portion meal product. At this point the customer 20, whether or not he participates in the system 10 via use of a card 24, may select a charity from those available to which a charitable donation will be made on his behalf. In the case of a customer 20 who previously supplied his card 24 and hence his default charity designation, the customer 20 may optionally change his choice of charity for the funds generated in the instant transaction.

The restaurant personnel 18 collects funds from the customer 20 at step 62, as a cash transaction, via a credit or debit card, or in any other manner, as well known in the art. The funds received for the reduced-portion meal product comprise a base amount comprising the cost of the reduced-portion meal product, and an excess amount comprising the difference between that cost and the price (which is the price of a full-portion meal product). The customer 20 may additionally be encouraged to “round up” his price to the next dollar or other convenient denomination by remitting additional funds.

At least the excess funds (less the restaurant's operating fee) and additional funds, if any, and the designated charity are recorded in the database 14. If the customer 20 has a card 24, his unique identifier is also provided to the database 14, where it is associated with the funds information.

Periodically, the financial transactions processor 16 will access the database 14, extract the funds and charity information, and unique identifier if present, and transfer the funds to a charitable organization 30, 32, 34, as depicted at step 66. In general, the amount donated to a charity 30, 32, 34 proceeding from a given reduced-portion meal product purchase will comprise the excess amount less the restaurant's operating fee, and any additional amount remitted by the customer, where the excess amount, as defined above, represents the difference between the cost of the reduced-portion meal product and the price of the reduced-portion meal product (which is the price of a corresponding full-portion meal product).

At predetermined time periods, such as annually, the charitable donations made on behalf of a customer 20 (as identified by his unique identifier and stored in the database 14) are summarized and documentation is sent to the customer (not shown in FIG. 2). Alternatively, this information may be stored and the documentation generated by the charity 30, 32, 34. Such an annual summary may be beneficial to the customer 20 upon preparing his taxes. Customers 21 that do not wish to obtain and use a unique identifier on a card 24 may obtain the same benefit by saving the receipts 22 from individual purchases of reduced-portion meal products over the year.

The system and method of the present invention thus simultaneously provide a health benefit to the customer 20, 21 in reducing his caloric intake of food high in fat, salt, and sugar; provide and facilitate an easy and convenient way for the customer 20, 21 to contribute to a charity such as hunger relief, and provide the customer 20, 21 with an additional incentive and benefit by documenting the charitable donations for tax purposes.

The system and method of the present invention additionally provides ample opportunity for the restaurant to take an active and participating role in the charitable giving. For example, a restaurant may chose to absorb the cost of implementing the tracking and funds transfer system, thus donating the customers' 20, 21 full excess amounts to the charity (i.e., without deducting an operating fee). Alternatively, the restaurant may lower its profits on the reduced-portion meal products, thus effectively increasing the excess amount portion of each purchase. Aside from the goodwill of community involvement and charitable giving, the restaurant may benefit from promotion of the system and method of the present invention in the form of beneficial press and public relations for actively supporting both healthy dietary alternatives and charitable giving. All of these forms of participation by the restaurant, and others readily realized by those of skill in the art, are within the broad practice of the present invention.

Although the present invention has been described herein with respect to particular features, aspects and embodiments thereof, it will be apparent that numerous variations, modifications, and other embodiments are possible within the broad scope of the present invention, and accordingly, all variations, modifications and embodiments are to be regarded as being within the scope of the invention. The present embodiments are therefore to be construed in all aspects as illustrative and not restrictive and all changes coming within the meaning and equivalency range of the appended claims are intended to be embraced therein.

1. A method of improving customer health and facilitating charitable giving, by a restaurant, comprising:
selling a reduced-portion meal product to a customer at the price of a corresponding full-portion meal product;
collecting at least said price in funds from the customer, said funds comprising a base amount corresponding to said reduced-portion meal product and an excess amount; and
transferring part of said excess amount to a charity on behalf of the customer.

2. The method of claim 1 wherein said excess amount of said funds includes the difference in cost of said reduced-portion meal product and said corresponding full-portion meal product.

3. The method of claim 1 further comprising transferring additional funds to said charity in an amount directed by the customer.

4. The method of claim 1 wherein the part of said excess amount transferred to the charity comprises said excess amount less an operating fee.

5. The method of claim 1 wherein the customer may select a charity from among a plurality of charities at the time of the sale.

6. The method of claim 1 wherein the customer is provided a receipt at the point of sale memorializing the transaction and indicating the amount of the charitable donation.

7. The method of claim 1 further comprising:
upon the customer's initial purchase of said reduced-portion meal product, providing the customer a unique identifier; and
upon subsequent purchases, using said unique identifier to identify the customer.

8. The method of claim 7 wherein said unique identifier is encoded on a card including at least one of an identification number, an optical code, a magnetic stripe, an RFID transponder, and an integrated circuit.

9. The method of claim 7 further comprising tracking the customer's charitable donations across multiple sales.

10. The method of claim 9 further comprising providing the customer with a summary of charitable donations over a predefined time period.

11. A system for facilitating charitable donations by a restaurant customer, comprising:
a point of sale station operative to process and record the sale of at least a reduced-portion meal product at the price of a corresponding full-portion meal product;
a database operative to record said reduced-portion meal product transaction, including funds received pursuant to said reduced-portion meal product transaction; and
a financial transaction processor operative to transfer funds to a charitable organization on behalf of the customer purchasing said reduced-portion meal product.

12. The system of claim 11 wherein said point of sale station includes an output device operative to produce a receipt memorializing the sale of said reduced-portion meal product, and indicating the funds transferred to said charitable organization on the customer's behalf.

13. The system of claim 11 wherein said database is operative to record reduced-portion meal product transactions from a plurality of said point of sale stations.

14. The system of claim 13 wherein said database is operative to record reduced-portion meal product transactions from said point of sale stations located in at least two restaurants.

15. The system of claim 11 wherein said point of sale station includes an input device operative to receive a unique customer identifier.

16. The system of claim 15 wherein said input device includes at least one of a numeric keypad, a microphone and voice recognition software, an optical scanner, a magnetic stripe reader, an RFID transponder reader, and an integrated circuit data interface.

17. The system of claim 15 wherein said database stores, for each customer that provides a unique customer identifier, at least the unique customer identifier and the funds transferred to a charitable organization on behalf of the customer.

18. The system of claim 17 wherein said database is operative to generate a summary of the funds transferred to a charitable organization on behalf of the customer over a predetermined time period.

19. The system of claim 11 wherein funds received pursuant to said reduced-portion meal product transaction include a base amount, an excess amount, and an optional additional amount, wherein the funds transferred to a charitable organization on behalf of the customer comprise a portion of said excess amount and said additional amount.

20. The system of claim 19 wherein the portion of said excess amount transferred to a charitable organization comprises said excess amount less an operating fee.
